(19) United States
(12) Patent Application Publication
(10) Pub. No.: US 2021/0079721 A1
(43) Pub. Date: Mar. 18, 2021

(54) SLAT COLLECTION DEVICE FOR INSULATED GLASS ASSEMBLY HAVING INTERNAL BLINDS

(71) Applicant: Xuezhong Zhang, Dalian City (CN)

(72) Inventor: Xuezhong Zhang, Dalian City (CN)

(21) Appl. No.: 16/572,818

(22) Filed: Sep. 17, 2019

(51) Int. Cl. E06B 9/32; E06B 9/266

(52) U.S. Cl. CPC E06B 9/32; E06B 9/266

(57) ABSTRACT

A slat collection device for an insulated glass assembly having an internal blind. The slat collection device includes a set of blinds slats with self-alignment slat ends, a bottom rail arranged at the bottom of the set of blinds slats, and two self-alignment channels arranged at opposite ends of the bottom rail. Each of the self-alignment channels has two side walls projecting outward and perpendicular to a rear wall. First and second horizontal connectors are mounted to the two self-alignment channels and to open ends disposed at the opposite ends of the bottom rail. When the set of blinds slats are stacked within the two self-alignment channels, each slat is aligned between the slat directly below on which it sits and the slat directly above which sits on it to prevent the slats from getting staggered front and back in the self-alignment channels when the blinds assembly is drawn.

### BACKGROUND OF THE INVENTION

### Technical Field

The invention relates to blinds assemblies, and in particular to a slat collection device for an insulated glass assembly having internal blinds.

### Description of Related Art

Insulated glass assemblies having internal blinds have the advantages of heat insulation and sound insulation of insulated glass as well as the functions of shielding against sunlight and obstructing the view through the glass assemblies. The blind assemblies are dust-free and have the unique advantages of long service life. Therefore, insulated glass assemblies are being used more and more widely and are becoming larger and larger in size. In order to ensure the airtightness of these insulated glass assemblies, the blind assemblies are typically magnetically controlled. However, magnetic operation and control on large-sized blinds assemblies will become increasingly more difficult due to the large weight of the slats and the large amount of friction generally created between the slats and window glass. The friction between the slats and the window glass may also cause damage to the coating on low-emissivity coated glass.

### BRIEF SUMMARY OF THE INVENTION

According to the present invention, there is disclosed a slat collection device for an insulated glass assembly having an internal blind. The slat collection device includes a set of blinds slats with self-alignment slat ends, a bottom rail arranged at the bottom of the set of blinds slats, and two self-alignment channels arranged at opposite ends of the bottom rail. Each of the two self-alignment channels has two side walls projecting outward and perpendicular to a rear wall. First and second horizontal connectors are mounted both to the two self-alignment channels and to open ends disposed at the opposite ends of the bottom rail. When the set of blinds slats are stacked within the two self-alignment channels, each slat is aligned between the slat directly below on which it sits and the slat directly above which sits on it to prevent the slats from getting staggered front and back in the self-alignment channels when the blinds assembly is drawn.

According to another aspect of present invention, there is disclosed a slat collection device for an insulated glass assembly having an internal blind. The device includes a set of blinds slats with self-alignment slat ends, a bottom rail arranged at the bottom of the set of blinds slats, and side edges of each of the self-alignment slat ends are bent downwards from an upper surface of the self-alignment slats to form concave channels which are open downwards away from the upper surface of each of the self-alignment slats.

According to still another aspect of present invention, there is disclosed a slat collection device for an insulated glass assembly having an internal blind. The device includes a set of blinds including self-alignment slats with self-alignment slat ends, each self-alignment slat having a first tab and a second tab at opposite ends thereof. Each of the first tab and second tabs is enclosed by first and second U-shaped notches, respectively, forming central portions of the two self-alignment slat ends of each self-alignment slat. The first tab and the second tabs being are bent downwards away from an upper surface of the self-alignment slats.

According to still another aspect of present invention, there is disclosed a slat collection device for an insulated glass assembly having an internal blind. The device includes a set of blinds including self-alignment slats with self-alignment slat ends. Each of the self-alignment slats has first and second rectangular openings at opposite ends thereof. The first and second rectangular openings at opposite ends of the self-alignment slats each have three fractured edges punched therethrough forming first and second tabs extending through the first and second rectangular openings of the self-alignment slat ends.

According to still another aspect of present invention, there is disclosed a slat collection device for an insulated glass assembly having an internal blind. The device includes a bottom rail arranged at the bottom of the set of blinds slats. When the set of blinds slats are stacked, each slat is aligned between the slat directly below on which it sits and the slat directly above which sits on it to prevent the slats from getting staggered front and back when the blinds assembly is drawn.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader and should not in any way be interpreted as limiting.

FIG. 1 is a three-dimensional exploded side view of the slat collection device, in accordance with the present invention;

FIG. 2 is a three-dimensional exploded side view of another embodiment of the slat collection device, in accordance with the present invention;

FIG. 3 is a three-dimensional exploded bottom view of the self-alignment channel shown in FIG. 2, in accordance with the present invention;

FIG. 4 is a three-dimensional exploded side view of a third embodiment, a self-alignment slat ends, in accordance with the present invention;

FIG. 5 is a three-dimensional exploded side view of a fourth embodiment, a self-alignment slat ends, in accordance with the present invention; and

FIG. 6 is a three-dimensional exploded side view of a fifth embodiment, a self-alignment slat ends, in accordance with the present invention.

### DETAILED DESCRIPTION OF THE INVENTION

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

A slat collection device 10 for an insulated glass assembly having an internal blind comprises a set of blinds slats with self-alignment slat ends, bottom rail arranged at the bottom of the set of blinds slats. The slat collection device 10 may further comprise two self-alignment channels arranged at the two ends of the bottom rail.

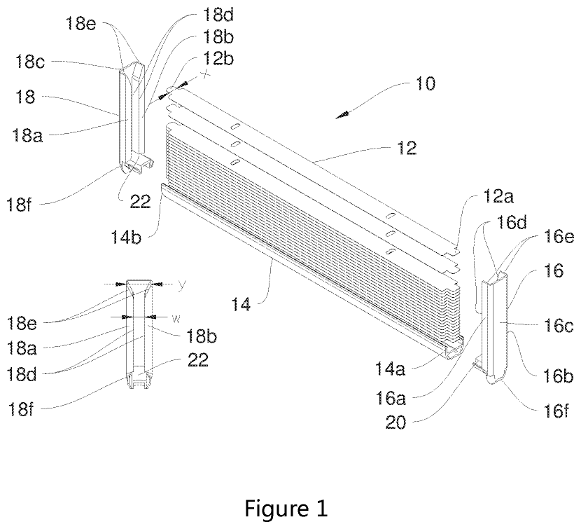

As shown in FIG. 1, the slat collection device 10 for an insulated glass assembly having internal blinds comprises a set of blinds slats 12 with a bottom rail 14 arranged at the bottom of the set of blinds slats. A pair of self-alignment channels 16 and 18 are arranged at the opposite ends 14a and 14b, respectively, of the bottom rail 14. Each of the channels 16 and 18 has two side walls 16a and 16b, and 18a and 18b, respectively, projecting outward and perpendicular to a rear wall 16c and 18c, respectively. The width w of the lower parts of the side U-shaped openings of 16d and 18d of the channels 16 and 18, respectively, are slightly wider than the width x of the slats ends 12a and 12b, but the width y of the top opening 16e and 18e of the channels 16 and 18 are much bigger than the width x, so that the ends 12a and 12b can easily fall into openings of 16e and 18e and then fit into the openings 16d and 18d, respectively, and be able to move up and down in the openings 16d and 18d.

The upper ends of the U-shaped openings 16d and 18d of the two self-alignment channels 16 and 18, respectively, are flared out from the elongated length of the inner side walls of the U-shaped openings 16d and 18d and arranged to face each other. First and second horizontal connectors 20 and 22 are mounted to the lower portions 16f and 18f of the two self-alignment channels 16 and 18 and are inserted into the open ends 14a and 14b, respectively, of the bottom rail 14.

Referring to FIG. 1, the slat collection device 10 for an insulated glass assembly having internal blinds has slats 12 with the opposite ends 12a and 12b of each slat being narrow as compared with the overall width of the slats. The ends 12a and 12b are received between the inner side walls of the u-shaped openings 16d and 18d.

Under the constraint of the self-alignment channels 16 and 18, the two ends 12a and 12b of the slats 12 are disposed to neatly stack and secure the slats within the self-alignment channels 16 and 18. When the slats 12 are stacked within self-alignment channels 16 and 18, each slat is aligned between the slat directly below on which it sits and the slat directly above which sits on it. The ends 12a and 12b of the slats 12 prevent the slats from getting staggered front and back in the self-alignment channels 16 and 18 when the blinds assembly is drawn. This is advantageous in that it prevents the slats from contacting the surface of glass.

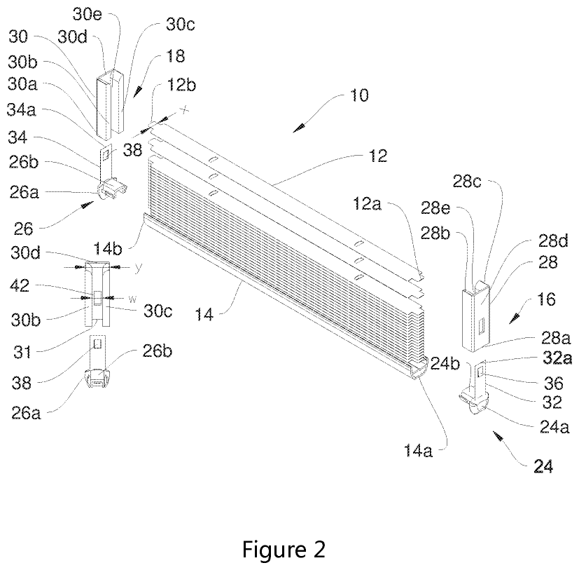

Referring to FIG. 2, there is illustrated an alternative embodiment of the slat collection device 10 for an insulated glass assembly having internal blinds described and illustrated in FIG. 1. Each of self-alignment channels 16 and 18 comprises a vertical trough 28 and 30, a first and second flat spring 32 and 34, and a first and second connector 24 and 26, respectively.

The first and second connectors 24 and 26 include end caps 24a and 26a, respectively, and horizontal inserts 24b and 26b, respectively, which are fixed to the two opposite ends 14a and 14b of the bottom rail 14. The horizontal inserts 24b and 26b are inserted into the open ends 14a and 14b of the bottom rail 14 as shown in FIG. 2.

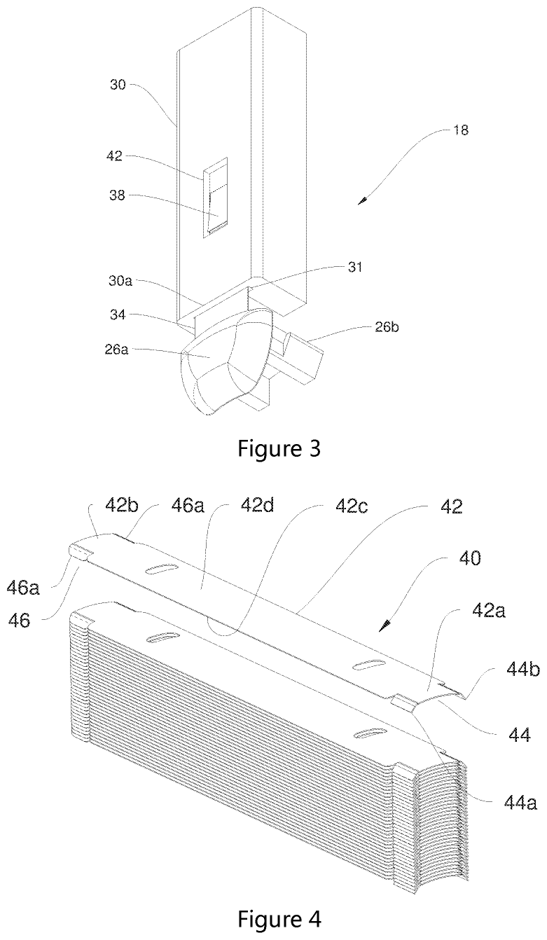

The end caps 24a and 26a of the first and second connectors 24 and 26 are removably secured to vertically disposed troughs 28 and 30 by upstanding flat springs 32 and 34. The lower ends of the upstanding flat springs 32 and 34 are fixed to the end caps 24a and 26a, as shown in FIGS. 2 and 3. The vertically disposed trough 28 have two side walls 28b and 28c connected by a rear wall 28d forming a channel 28e therebetween. At the intersection of the two side walls 28b and 28c and the rear wall 28d, a slot 29 is formed in the side walls 28b and 28c of the vertically disposed connectors 28. The vertically disposed trough 30 have two side walls 30b and 30c connected by a rear wall 30d forming a channel 30e therebetween. At the intersection of the two side walls 30b and 30c and the rear wall 30d, a slot 31 is formed in the side walls 30b and 30c of the vertically disposed connectors 30. It is within the terms of the present invention for the slots 29 and 31 to extend the length of the side walls 28b and 28c, 30b and 30c and the rear wall 28d and 30d.

The upper ends 32a and 34a of the upstanding first and second flat springs 32 and 34, respectively, are inserted in the slots 29 and 31 opening to the lower end 28a and 30a of the vertically disposed troughs 28 and 30.

The horizontal inserts 24b and 26b are inserted into open ends 14a and 14b of the bottom rail 14.

The upstanding flat springs 32 and 34 have a locking projection 36 and 38 extending outward therefrom. The vertically disposed troughs 28 and 30 have an opening 40 and 42, respectively, therethrough, as seen in FIG. 3. The openings 40 and 42 are disposed to receive locking projection 36 and 38, respectively, when the upstanding flat springs 32 and 34, respectively, are inserted in the slots 29 and 31 so that the upstanding flat springs 32 and 34 are removably mounted to the vertically disposed troughs 28 and 30. The upstanding flat springs 32 and 34 can be constructed of a springy material such as plastic or steel sheet, to allow for bending movement of the troughs of 28 and 30 towards slats 12.

The lower edges of the openings 40 and 42 are below the lower edges of the locking projections 36 and 38 for some distance so the vertically disposed troughs 28 and 30 can move upwards or downwards on the upstanding flat springs 32 and 34 for the same distance, and can incline leftwards or rightwards relative to the bottom rail 14 when the bottom rail 14 is not kept horizontal for some reasons, for instance, when the end cap 26a is higher than the end cap 24a or vice versa.

The vertically disposed trough 28 at the right end of the bottom rail 14 can still be kept vertical under the constraint of an insulated glass spacer and has an angle smaller than 90° relative to the bottom rail 14. In this case, the corresponding bendable, flat springs 32 and 34 can prevent distortional fractures of the vertically disposed troughs 28 and 30 at the right and left ends of the rail 14, and accordingly, prevent the bottom rail 14 from getting stuck.

Referring to FIG. 4, there is shown an alternative embodiment of the slat collection device 10 for an insulated glass assembly having internal blinds. The internal blinds 40 include a stack of self-alignment slats 42.

The side edges 44a and 44b, 46a and 46b of each of the two self-alignment slat ends 42a and 42b of each self-alignment slat 42 are bent downwards from the upper surface 42d to form concave channels 44 and 46 which are open downwards away from the upper surface 42d of each self-alignment slat 42. Each self-alignment slat 42 are disposed to neatly stack and secure the slats ends within the concave channels 44 and 46 of the above slat. Further, each slat is aligned between the slat directly below on which it sits and the slat directly above which sits on it. The concave channels 44 and 46 prevent the self-alignment slats 42 from getting staggered front and back when the blinds assembly is drawn. This is advantageous in that it prevents the self-alignment slats 42 from contacting the surface of glass.

When the blinds assembly is drawn upwards, each self-alignment slat 42 is forced to be automatically aligned to the slat below under the constraint of the concave channels 44 and 46 and the side edges 44a and 44b, 46a and 46b which are open downwards at the two ends of the slat, so as to fall over the slat below. The self-alignment slats 42 are automatically aligned without getting staggered front and back and thus will not make contact with the surface of glass.

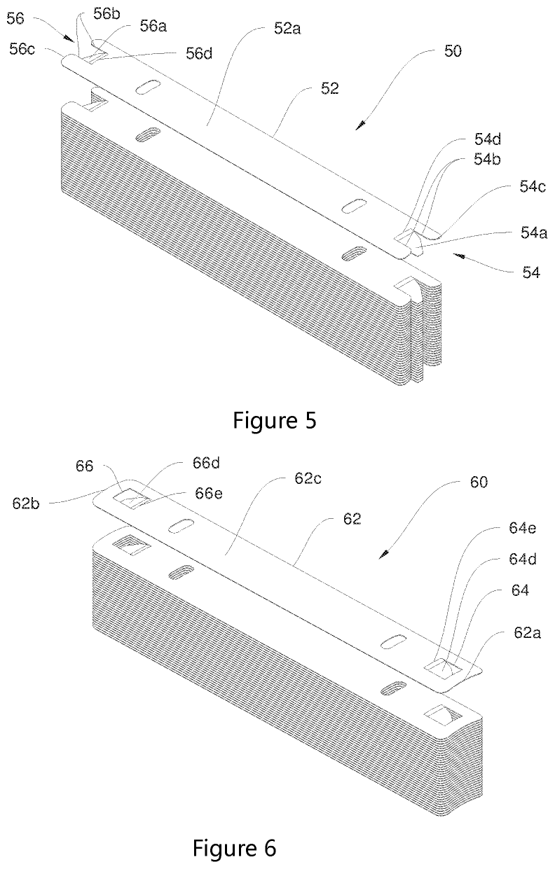

Referring to FIG. 5, there is shown an alternative embodiment of the slat collection device 10 for an insulated glass assembly having internal blinds described hereinbefore. The internal blinds 50 include a stack of self-alignment slats 52. A first and second tab 54a and 56a forming the central portions of the two self-alignment slat ends 54 and 56 of each slat is bent downwards away from the upper surface 52a of the slats. The first and second tabs 54a and 56a are enclosed by two U-shaped notches 54b and 56b, respectively, opening at the end surfaces 54c and 56c. The first and second tabs 54a and 56a are secured at their rear edges 54d and 56d to the two U-shaped notches 54b and 56b. The tabs 54a and 56a are bent downward away from the upper surface 52a of the slats 52. The width of ends of the tabs are narrowed to guide the tabs 54a and 56a to fall into the U-shaped notches 54b and 56b easily.

When the blinds assembly is drawn upwards, the bent tabs 54a and 56a of each self-alignment slats 52 fall into the U-shaped notches 54b and 56b, respectively, of the adjacent slat so that all the slats are automatically aligned without getting staggered front and back so as to prevent contact with the surface of glass.

This is because each self-alignment slat 52 is forced to be automatically aligned to the slat disposed directly below under the constraint of the U-shaped notches 54b and 56b for the bent tabs 54a and 56a, respectively, which are bent downwards, at the two ends of the slat, so as to fall over the slat below. The slats are automatically aligned without getting staggered front and back and thus will not make contact with the surface of glass.

Referring to FIG. 6, there is shown an alternative embodiment of the slat collection device 10 for an insulated glass assembly having internal blinds described hereinbefore. The internal blinds 60 include a stack of self-alignment slats 62 each having first and second rectangular openings 64 and 66, respectively, provided at the self-alignment slat ends 62a and 62b and extending through the slats 62. The first and second rectangular openings 64 and 66 having three fractured edges is punched in each of the two ends 62a and 62b of the slats. First and second rectangular tabs 64d and 66d are formed by the rectangular openings 64 and 66 being punched downwards. The first and second tabs 64d and 66d are secured at their rear edges 64e and 66e to the two rectangular openings 64 and 66. Tabs 64d and 66d are bent downward into the rectangular openings from the outer surface 62c. The width of the ends of the tabs 64d and 66d are narrowed to guide the tabs 64d and 66d to easily fall down into the openings 64 and 66 of the slats disposed below. When the blinds assembly is drawn upwards, the bent tabs 64d and 66d of each slat fall into the rectangular openings of the slat below, so that all the slats are automatically aligned without getting staggered front and back and will not make contact with the surface of glass.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A slat collection device for an insulated glass assembly having an internal blind comprising:
a set of blinds slats with self-alignment slat ends;
a bottom rail arranged at the bottom of the set of blinds slats;
two self-alignment channels arranged at opposite ends of the bottom rail;
each of the two self-alignment channels having two side walls projecting outward and perpendicular to a rear wall;
first and second horizontal connectors mounted both to the two self-alignment channels and to open ends disposed at the opposite ends of the bottom rail; and
when the set of blinds slats are stacked within the two self-alignment channels, each slat is aligned between the slat directly below on which it sits and the slat directly above which sits on it to prevent the slats from getting staggered front and back in the self-alignment channels when the blinds assembly is drawn.

2. The slat collection device of claim 1 wherein openings of the two self-alignment channels are slightly wider than the width of the slats ends, but the width of top openings of the two self-alignment channels are bigger than the width of the slats ends, so that the slat ends can easily fall first into the top openings then fit into the U-shaped openings, respectively, and be able to move up and down in the U-shaped openings.

3. The slat collection device of claim 2 wherein upper ends of the U-shaped openings of the two self-alignment channels, respectively, are flared out from an elongated length of inner side walls of the U-shaped openings and arranged to face each other.

4. The slat collection device of claim 3 wherein horizontal connectors are mounted to lower portions of the two self-alignment channels and are inserted into the open ends disposed at the opposite ends of the bottom rail.

5. The slat collection device of claim 4 wherein the self-alignment slat ends are narrow as compared to the overall width of the self-alignment slats and are received between the inner side walls of the U-shaped openings.

6. The slat collection device of claim 5 wherein the self-alignment slat ends are disposed to neatly stack and secure the self-alignment slats ends within the self-alignment channels, such that each self-alignment slat is aligned between the slat directly below on which it sits and the slat directly above which sits on it.

7. The slat collection device of claim 1 further including first and second flat springs attached to first and second connectors, respectively.

8. The slat collection device of claim 7 wherein the first and second connectors include end caps and horizontal inserts, which are inserted into the open ends on the two opposite ends of the bottom rail.

9. A slat collection device for an insulated glass assembly having an internal blind comprising:
a set of blinds slats with self-alignment slat ends;
a bottom rail arranged at the bottom of the set of blinds slats; and
side edges of each of the self-alignment slat ends being bent downwards from an upper surface of the self-alignment slats to form concave channels which are open downwards away from the upper surface of each of the self-alignment slats.

10. The slat collection device of claim 9 wherein each of the self-alignment slats are disposed to neatly stack and secure the self-alignment slat ends within the concave channels of the above self-alignment slat, such that the concave channels prevent the self-alignment slats from getting staggered front and back when the blinds assembly is drawn.

11. A slat collection device for an insulated glass assembly having an internal blind comprising:
a set of blinds including self-alignment slats with self-alignment slat ends;
each self-alignment slat having a first tab and a second tab at opposite ends thereof;
each of the first tab and second tabs enclosed by first and second U-shaped notches, respectively, forming central portions of the two self-alignment slat ends of each self-alignment slat; and
the first tab and the second tabs being bent downwards away from an upper surface of the self-alignment slats.

12. The slat collection device of claim 11 wherein ends of the first and second tabs are narrowed at their free ends to guide the first and second tabs to fall into the U-shaped notches of the adjacent self-alignment slat so that all the self-alignment slats are automatically aligned without getting staggered front and back.

13. A slat collection device for an insulated glass assembly having an internal blind comprising:
a set of blinds including self-alignment slats with self-alignment slat ends;
each of the self-alignment slats having first and second rectangular openings at opposite ends thereof; and
the first and second rectangular openings at opposite ends of the self-alignment slats each having three fractured edges punched therethrough forming first and second tabs extending through the first and second rectangular openings of the self-alignment slat ends.

14. The slat collection device of claim 13 wherein the width of free ends of the first and second tabs are narrowed to guide the first and second tabs to fall into the first and second rectangular openings of an adjacent self-alignment slat disposed below and against a self-alignment slat disposed directly below so that all the self-alignment slats are automatically aligned without getting staggered front and back.

15. A slat collection device for an insulated glass assembly having an internal blind comprising:
a set of blinds slats with self-alignment slat ends;
a bottom rail arranged at the bottom of the set of blinds slats; and
when the set of blinds slats are stacked, each slat is aligned between the slat directly below on which it sits and the slat directly above which sits on it to prevent the slats from getting staggered front and back when the blinds assembly is drawn.

16. The slat collection device of claim 15 further comprising:
two self-alignment channels arranged at opposite ends of the bottom rail;
each of the two self-alignment channels having two side walls projecting outward and perpendicular to a rear wall;
first and second horizontal connectors mounted both to the two self-alignment channels and to open ends disposed at the opposite ends of the bottom rail; and
when the set of blinds slats are stacked within the two self-alignment channels, each slat is aligned between the slat directly below on which it sits wherein lower parts of U-shaped openings of the two self-alignment channels are slightly wider than the width of the slats ends, but the width of top openings of the two self-alignment channels are bigger than the width of the slats ends, so that the slat ends can easily fall first into the top openings then fit into the U-shaped openings, respectively, and be able to move up and down in the U-shaped openings, and
wherein the self-alignment slat ends are narrow as compared to the overall width of the self-alignment slats and are received between the inner side walls of the U-shaped openings.

17. The slat collection device of claim 16 wherein horizontal connectors are mounted to lower portions of the two self-alignment channels and are inserted into the open ends disposed at the opposite ends of the bottom rail.

18. The slat collection device of claim 15 wherein side edges of each of the self-alignment slat ends are bent downwards from an upper surface to form concave channels which are open downwards away from the upper surface of each of the self-alignment slats.

19. The slat collection device of claim 15 wherein a first and second tab, each enclosed by two U-shaped notches, form central portions of the two self-alignment slat ends of each self-alignment slat and are bent downwards away from the upper surface of the self-alignment slats.

20. The slat collection device of claim 15 wherein the self-alignment slats each have first and second rectangular openings, each having three fractured edges punched therethrough forming tabs, extending through the self-alignment slat ends.
